(19) United States
(12) Patent Application Publication
(10) Pub. No.: US 2013/0072386 A1
(43) Pub. Date: Mar. 21, 2013

(54) PHYSICAL MAP CONSTRUCTION OF WHOLE GENOME AND POOLED CLONE MAPPING IN NANOCHANNEL ARRAY

(71) Applicants: Ming Xiao, Huntington Valley, PA (US); Alex Hastie, San Diego, CA (US)

(72) Inventors: Ming Xiao, Huntington Valley, PA (US); Alex Hastie, San Diego, CA (US)

(73) Assignee: BIONANO GENOMICS, INC., San Diego, CA (US)

(21) Appl. No.: 13/606,819

(22) Filed: Sep. 7, 2012

Related U.S. Application Data
(60) Provisional application No. 61/532,217, filed on Sep. 8, 2011.

(51) Int. Cl. C40B 20/00; C40B 60/10

(52) U.S. Cl. 506/2; 506/38

(57) ABSTRACT

Methods for generating physical maps for polynucleotides, such as genomic DNA, are disclosed herein. Also disclosed are methods for identifying the source of polynucleotides. The methods can, for example, be used in physical map construction of whole genome. In addition, methods and systems capable of performing high throughput characterization of macromolecules using nanofludic devices are enclosed.

### CROSS-REFERENCE TO RELATED APPLICATIONS

The present application claims priority under 35 U.S.C. §119(e) to U.S. Provisional Application No. 61/532,217, filed on Sep. 8, 2011, which is hereby expressly incorporated by reference in its entirety.

### STATEMENT REGARDING FEDERALLY SPONSORED R&D

The invention was made with government support under RO1 HG005946 awarded by National Institutes of Health. The government has certain rights in the invention.

### BACKGROUND OF THE INVENTION

1. Field of the Invention

The present application relate generally to the field of nucleic acid analysis. More particular, the application relates to genomic analysis, such as genome mapping, using nanochannels.

2. Description of the Related Art

The construction of a whole-genome physical map has been an essential component of numerous genome projects initiated since the inception of the Human Genome Project (HGP) (Collins & Galas, Science 262, 43-46 (1993)). Currently, a physical map usually comprises a set of ordered large-insert clones such as Bacterial Artificial Chromosomes (BACs) (Shizuya et al., Proc. Natl Acad. Sci. USA 89, 8794-8797 (1992)), which have largely replaced Yeast Artificial Chromosomes (YACs) (Burke et al., Science 236, 806-812 (1987)) as the preferred building blocks of a physical map. Physical maps can be independent of genetic information but are more valuable if linked to genetically mapped markers, and are even more powerful if integrated with genomic sequence data.

It has been shown that whole genome shotgun (WGS) sequencing alone isn't sufficient to produce a linearly ordered set of sequences if the sequence contigs are not coupled to a robust physical map (Green, Nature Rev. Genet. 2, 573-583 (2001); Lander & Waterman, Genomics 2, 231-239 (1988); Istrail et al., Proc. Natl. Acad. Sci. USA 101, 1916-1921 (2004); Myers et al., Proc. Natl Acad. Sci. USA 99, 4145-4146 (2002); Waterston et al., Proc. Natl. Acad. Sci. USA 99, 3712-3716 (2002)), especially for the multiploid genomes such as plant genomes. The lack of high-quality physical maps can rapidly become one of the limiting factors in assembling newly generated WGS sequences for large genomes. Therefore, there is a need for constructing whole genome physical maps in a high throughput way at very low cost.

In addition, genomes are enriched in many forms of variants, including single nucleotide polymorphisms and structural variations. There has been an explosion of data describing newly recognized structural variants in the human genome and their associations with a variety of diseases. Feuk et al., Nature Reviews Genetics 7, 85-97 (2006); Szatmari et al., Nature Genetics 39, 319-328 (2007). Despite recent advances in technologies in detection and confirmation of structural variants, there is still an urgent need for technologies to assess structural variants more accurately and rapidly. Estivill et al., Hum. Mol. Genet., 11, 1987-1995 (2002); Locke et al., Genome Res., 13, 347-357 (2003); Korbel et al., Science, 318, 420-426 (2007); Tuzun et al., Nature Genetics, 37, 727-732 (2005). Once discovered, novel structural variants still need to be confirmed and validated, generally relying on laborious and low throughput PCR or Fluorescence In Situ Hybridization methods. Therefore, there is a need for methods capable of validating variants with high efficiency and accuracy.

### SUMMARY OF THE INVENTION

Some embodiments provide a method for identifying the source of polynucleotides, where the method comprises: providing a plurality of biological samples wherein each of the plurality of biological samples comprises a polynucleotide; combining the plurality of biological samples in a plurality of pools, wherein each biological sample is present in at least two pools; obtaining structural information of the polynucleotides present in each pool; and assigning the polynucleotides to corresponding biological samples using the structural information obtained for the polynucleotides.

In some embodiments, the biological samples comprise plasmids, fosmids, cosmids, viral vectors, artificial chromosome clones, or any combinations thereof. In some embodiments, the biological samples comprise randomly sheared or restriction enzyme generated polynucleotide fragments or such fragments carried in plasmids, fosmids, cosmids, viral vectors, artificial chromosome clones, or any combinations thereof. In some embodiments, the artificial chromosome clones are Bacterial Artificial Chromosomes, Yeast Artificial Chromosomes, or any combinations thereof. In some embodiments, each of the polynucleotide fragment present in the artificial chromosomes is a fragment of a genomic DNA.

In some embodiments, the obtaining structural information of the polynucleotides comprises sequencing at least a portion of the polynucleotides. In some embodiments, the obtaining structural information of the polynucleotides comprises labeling the polynucleotides present in each pool, and linearizing, in a nanochannel fluidic device, at least a portion of the labeled polynucleotides.

In some embodiments, the polynucleotides present in one pool are loaded into the nanochannel fluidic device as one sample. In some embodiments, the polynucleotides present in one pool are analyzed in the nanochannel fluidic device simultaneously.

In some embodiments, the labeling comprises nicking, flap-labeling, or any combination thereof. In some embodiments, the labeling comprises labeling one or more different sequence motifs. In some embodiments, the labeling comprises labeling two or more different sequence motifs by the same or different labels. In some embodiments, the different sequence motifs are labeled by different labels.

In some embodiments, the assigning the polynucleotides to corresponding biological samples comprises comparing the structural information of the polynucleotides present in each pool. In some embodiments, the structural information of the polynucleotides comprises patterns of distances between labels on the polynucleotides, intensity of the labels on the polynucleotides, or both.

In some embodiments, each of the polynucleotides comprises a pool-specific identifier. In some embodiments, the pool-specific identifier is about 5 kb to about 50 kb. In some embodiments, each of the pool-specific identifier differs from other pool-specific identifiers in nicking patterns.

In some embodiments, the method further comprises combining the plurality of pools in a plurality of super-pools, wherein at least one of the super-pools comprises two or more of the pools. In some embodiments, the polynucleotides present in one super-pool are loaded into the nanochannel fluidic device as one sample. In some embodiments, the assigning the polynucleotides to corresponding biological samples comprises assigning the polynucleotides to corresponding pool based on the pool-specific identifiers present in the polynucleotides.

Some embodiments disclosed herein provide a method for generating a physical map of a polynucleotide, where the method comprises: providing a sample polynucleotide; generating a library of sub-polynucleotide clones wherein each sub-polynucleotide clone comprises a fragment of the sample polynucleotide; combining the sub-polynucleotide clones in a plurality of pools, wherein each sub-polynucleotide clone is present in at least two pools; labeling one or more regions of the fragments of the sample polynucleotide; linearizing, in nanochannels, at least a portion of the labeled region of the fragments of the sample polynucleotide; and obtaining structural information of the fragments of the sample polynucleotides based on the linearized and labeled fragments of the sample polynucleotide to generate a physical map of the sample polynucleotide.

In some embodiments, the sample polynucleotide is a genomic DNA.

In some embodiments, the method further comprises assigning the fragments of the sample polynucleotide to corresponding sub-polynucleotide clones based on the structural information obtained for the fragments of the sample polynucleotides.

In some embodiments, the structural information of the polynucleotides comprises patterns of distances between labels on the polynucleotides, intensity of the labels on the polynucleotides, or both.

In some embodiments, the polynucleotides present in one pool are loaded into the nanochannels as one sample.

In some embodiments, the labeling comprises nicking, flap-labeling, or any combination thereof. In some embodiments, the labeling comprises labeling two or more different sequence motifs by the same or different labels. In some embodiments, the different sequence motifs are labeled by different labels.

In some embodiments, each of the polynucleotides comprises a pool-specific identifier. In some embodiments, the method further comprises combining the plurality of pools in a plurality of super-pools, wherein each of the super-pool comprises one or more of the pools. In some embodiments, the polynucleotides present in one super-pool are loaded into the nanochannels as one sample.

In some embodiments, the assigning the polynucleotides to corresponding sub-polynucleotide clones comprises assigning the polynucleotides to corresponding pool based on the pool-specific identifiers present in the polynucleotides.

Some embodiments disclosed herein provide a high throughput method of characterizing macromolecules using a nanofluidic device, where the method comprises: labeling a plurality of macromolecules, wherein each macromolecule is labeled on at least two locations and wherein the plurality of macromolecules comprises at least 20 macromolecules; translocating the labeled macromolecules through a nanochannel array, wherein at least a portion of the labeled macromolecules is elongated within the nanochannel array and wherein the nanochannel array comprises two or more nanochannels; monitoring one or more signals related to the translocation of the labeled macromolecules through the nanochannel array, wherein signals from at least 20 macromolecules are monitored simultaneously, wherein the monitoring comprises determining the distance between labels on the labeled macromolecules; and correlating the distances between the labels to one or more characteristics of the macromolecules.

In some embodiments, the plurality of macromolecules is loaded onto the nanochannel array as one sample. In some embodiments, the monitoring one or more signals related to the translocation of the labeled macromolecules comprises capturing the information of signals in a computer. In some embodiments, the plurality of macromolecules comprise proteins, single-stranded DNA, double-stranded DNA, RNA, siRNA, or any combination thereof.

Some embodiments provides a system, comprising: a nanochannel array, wherein the nanochannel array comprises at least 50 nanochannels; an image collector capable of capturing an image of the nanochannel array; and a computer processor configured to manipulate one or more images of the nanochannel array gathered by the image collector.

In some embodiments, the image collector is capable of capturing an image of the entire nanochannel array simultaneously. In some embodiments, the image collector further comprises a scanner which is configured to scan the nanochannel array to capture images of portions of the nanochannel array. In some embodiments, the image collector has a single field of view of at least about 50 micron×50 micron.

In some embodiments, the image collector is capable of capturing an image of at least about 50 nanochannels simultaneously. In some embodiments, the image collector is capable of capturing an image of at least about 160 nanochannels simultaneously.

### BRIEF DESCRIPTION OF THE DRAWINGS

FIG. 1 is a schematic illustration of a non-limiting example of physical map.

FIG. 2 is a schematic illustration of a non-limiting example of the pooling method disclosed herein to identify the source of a biological sample.

FIG. 3A is a schematic illustration of a Cre-LoxP recombination system-based linearization of bacterial artificial chromosomes (BACs). FIG. 3B is a schematic illustration of a non-limiting example of barcoding BAC DNA with pool-specific identifiers using a Cre-LoxP recombination system and generation of super-pools.

FIG. 4A-D shows a non-limiting example of nanochannel array chip.

FIG. 5A-D shows nick-flap labeling of lambda DNAs.

FIG. 6 shows analysis of BAC DNA using nanochannels, and collection and clustering of BAC pool data.

FIG. 7A shows clustering of BAC DNA molecules with filtered clustered at the bottom. FIG. 7B shows a typical cluster of BAC DNA molecules with both orientations.

FIG. 8 shows a scaffold map generated from four overlapping BAC clones.

FIG. 9 shows a physical map of a 4.67 Mb MHC region on human chromosome 6 generated using the consensus map of the BAC libraries.

FIG. 10 shows 5.9 kb insertions observed in PGF clone compared to the COX clone.

FIG. 11 shows insertions and deletions observed in a 4.67 Mb MHC region on human chromosome 6 in different haplotypes.

FIG. 12 shows variation in nicking pattern observed in a 4.67 Mb MHC region on human chromosome 6 in different haplotypes.

FIG. 13 shows duplications observed in PGF clone compared to the COX clone.

FIG. 14 show the improvement of sequence assembly by using physical maps described herein.

FIG. 15 shows generation of physical map using multiple sequence motifs and multiple colors.

FIG. 16 shows improvement of sequence assembly using the physical map generated by the use of multiple sequence motifs and multiple colors.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Disclosed herein are high throughput methods and systems for analyzing macromolecules using a nanofluidic device. The methods and systems can, for example, be used to obtain structural information and generate physical maps of macromolecules, such as polynucleotides. Also disclosed herein are methods of identifying the source of polynucleotides and methods of generating a physical map of a polynucleotide, such as a genomic DNA.

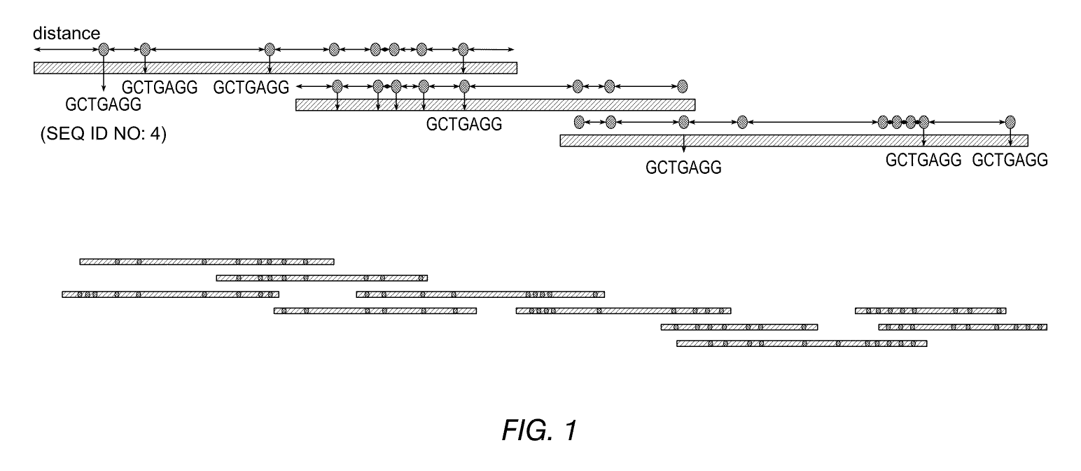

As disclosed herein, a “physical map” refers to an ordered set of DNA fragments with a sequential order of specific sequence motifs (such as GCTGAGG), among which the distances between the sequence motifs are expressed in physical distance units (base pairs). FIG. 1 illustrates a non-limiting example of physical map, wherein each DNA fragment is compared and aligned with other DNA fragments base on the overlapping sequential order of the sequence motifs.

As used herein, “macromolecules” refer to large biological polymers, such as double-stranded DNA, single-stranded DNA, RNA, polypeptides, carbohydrates, and any combinations thereof.

### Nanochannels

As used herein, the term “channel” refers to a region defined by borders. Such borders can be physical, electrical, chemical, magnetic, and the like. The term “nanochannel” is used to clarify that certain channels are considered nanoscale in certain dimensions.

Nanochannels, for example nanochannels having diameters below 200 nm, have been shown to linearize DNA molecules, thus preventing the molecule from bending back on itself and completely precluding the native Gaussian coil configuration normally assumed in free solution. Such conformational constraints are ideal vehicles for single molecule DNA analysis.

Nanochannels are distinct from nanopores in that nanopores have a very low aspect ratio (length/diameter) while nanochannels have a high aspect ratio. Typically, nanopores are 0.5 to 100 nm in diameter but only a few nm in length. Nanochannels can be of similar diameter but are at least 10 nm in length. The cross-sectional dimension of the nanochannel can vary, for example, the nanochannel can have a characteristic cross-sectional dimension of no more than about 500 nm, no more than about 300 nm, no more than about 200 nm, no more than about 100 nm, no more than about 75 nm, no more than about 50 nm, no more than about 40 nm, no more than about 30 nm, no more than about 20 nm, no more than about 10 nm, no more than about 5 nm, no more than about 2 nm, or no more than about 0.5 nm. The width of the nanochannel can vary, for example the width of the nanochannel can be no more than about 300 nm, no more than about 200 nm, no more than about 100 nm, no more than about 75 nm, no more than about 50 nm, no more than about 40 nm, or no more than about 30 nm. In some embodiments, the width of the nanochannel is about 20 nm to about 300 nm, for example about 45 nm. The depth of the nanochannel can vary, for example the depth of the nanochannel can be no more than about 300 nm, no more than about 200 nm, no more than about 100 nm, no more than about 75 nm, no more than about 50 nm, or no more than about 30 nm. In some embodiments, the depth of the nanochannel is about 30 nm to about 300 nm, for example about 45 nm.

The length of the nanochannel can also vary, for example from about 10 nm to about 10 cm. The length of the nanochannel can also be at least about 10 nm, at least about 100 nm, at least about 1 micron, at least about 10 micron, at least about 100 micron, at least about 500 micron, at least about 1000 micron, at least about 5000 micron, at least about 10000 micron, or longer. In some embodiments, the length of the nanochannel is about 10 micron to about 10000 micron, for example about 350 micron.

The nanochannel can have one or more linear segments. The length of a linear segment in the nanochannel can vary, for example from about 10 nm to about 10 cm, or from about 100 nm to about 1 cm. In some embodiments, the nanochannel has a linear segment having a length of about 10 nm, about 100 nm, about 1 micron, about 10 micron, about 100 micron, about 500 micron, about 1000 micron, about 5000 micron, about 10000 micron, or a range between any two of these values. In some embodiments, the length of a linear segment in the nanochannel is about 10 micron to about 10000 micron, for example about 350 micron.

Nanochannels can be straight, parallel, interconnected, curved, or bent. Preferably, a nanochannel include at least one essentially straight portion in the length of from about 10 nm to about 100 cm, or in the range of from about 100 nm to about 10 cm, or from about 1 mm to about 1 cm. In some embodiments, nanochannels are arranged in a back-and-forth, radiator-type pattern on a surface. In some embodiments, the nanochannel is circular or can be in a spiral configuration. A nanochannel can possess a constant width and/or depth, but can also have a width and/or a depth that varies.

In some embodiments, one or more nanochannels are present in a nanochannel array, for example, a nanochannel array chip. In some embodiments, the nanochannels are present in the nanochannel array at a density of at least one nanochannel per cubic centimeter. In some embodiments, the nanochannels are present at a density of at least about 10, at least about 30, at least about 50, at least about 75, at least about 100, at least about 150, or at least about 200 nanochannels per cubic centimeter. The number of nanochannels present in a nanochannel array can vary, for example, a nanochannel array can have at least about 2, at least about 10, at least about 20, at least about 30, at least about 50, at least about 100, at least about 150, at least about 200, or at least about 250 nanochannels. Two or more nanochannels in a nanochannel array can be interconnected. A nanochannel can have a constant cross-section or it can vary in cross-section, depending on the users' needs.

Borders that define the nanochannels can have various configurations. The border can be a physical wall, a ridge, or the like. In some embodiments, the border includes an electrically charged region, a chemically-treated region, a region of magnetic field, or the like. Hydrophobic and hydrophilic regions are considered especially suitable borders. In some embodiments, borders are formed from differing materials, for example, strips of glass, plastic, polymer, or metal. In some embodiments, borders are formed by self-assembling monolayers (SAMs). In some embodiments, the nanochannels are of an inverse construction wherein exposed surface defines the borders of the nanochannel, and the central lane of the channel is qualitatively different from the exposed bordering surface. Nanochannels are suitably capable of confining at least a portion of a macromolecule so as to elongate or unfold that portion of the macromolecule. For example, a macromolecule that is hydrophilic can be elongated by placement or disposition within a nanochannel bounded by hydrophobic borders. In this instance, the macromolecule can be constrained by the borders and become elongated.

Various nanochannels and nanochannel arrays have been described, for example, in U.S. Pat. Nos. 7,217,562 and 7670770, and International patent application published as WO2009/149362, all of which are incorporated herein by reference.

### Analysis of Macromolecules Using a Nanofluidic Device

Methods of analyzing macromolecules are disclosed herein. The methods include disposing one or more macromolecules onto a surface having one or more nanochannels capable of constraining at least a portion of the macromolecule so as to maintain in linear form that portion of the macromolecule, subjecting the one or more macromolecules to a motivating force so as to elongate at least a portion of one or more macromolecules within one or more nanochannels, and monitoring one or more signals evolved from one or more of the macromolecules.

In some embodiments, the method comprises: labeling a plurality of macromolecules, wherein each macromolecule is labeled on at least two locations; translocating the labeled macromolecules through a nanochannel array, wherein at least a portion of the labeled macromolecules is elongated within the nanochannel array and wherein the nanochannel array comprises two or more nanochannels; monitoring one or more signals related to the translocation of the labeled macromolecules through the nanochannel array wherein the monitoring comprises determining the distance between labels on the labeled macromolecules; and correlating the distances between the labels to one or more characteristics of the macromolecules. In some embodiments, the nanochannel array has at least about 20 nanochannels. In some embodiments, signals from at least about 20 macromolecules are monitored simultaneously,

The ways by which the macromolecules are loaded into the nanochannels are not particularly limited. For example, the macromolecules can be dispensed, dropped, or flowed to the surface on which the nanochannels are located. Macromolecules can be carried in a fluid, such as water, a buffer, and the like, to aid their disposition onto the surfaces. The carrier fluid can be chosen according to the needs of the user, and suitable carrier fluids will be known to those of ordinary skill in the art.

The method by which the macromolecules are labeled are not particularly limited, for example, the labeling can be achieved by using any methods known in the art, for example, binding a fluorescent label, a radioactive label, a magnetic label, or any combination thereof to one or more regions of the macromolecule. Binding can be accomplished where the label is specifically complementary to a macromolecule or to at least a portion of a macromolecule or other region of interest.

In some embodiments, the labeling comprises nicking, flap-labeling, or any combination thereof. Nicking can be achieved by exposing the macromolecule, e.g., a double-stranded DNA, to a nicking endonuclease, or nickase. In some embodiments, nickases are highly sequence-specific, meaning that they bind to a particular nucleic acid sequence (sequence motif) with a high degree of specificity. Non-limiting examples of nickases are available, e.g., from New England BioLabs. The nicking can also be accomplished by other conventional technques known in the art, for example, by other enzymes that effect a break or cut in a strand of DNA, or by exposure to electromagnetic radiation (e.g., UV light), one or more free radicals, and the like.

For example, a double-stranded DNA can be nicked to form an unhybridized flap of its first DNA strand and a corresponding region on its second DNA strand; and the first DNA strand can be extended along the corresponding region of the second DNA strand; and then at least a portion of the unhybridized flap, a portion of the extended first DNA strand, or both can be labeled. The length of the unhybridized flap can vary, from example, from about 1 to about 1000 bases. For example, the length of the unhybridized flap can be about 2 bases, about 5 bases, about 10 bases, about 20 bases, about 30 bases, about 50 bases, about 100 bases, about 500 bases, about 1000 bases, or a range between any two of these values.

Incorporation of replacement bases into the first strand (i.e., the nicked strand) of double-stranded DNA can comprise contacting the DNA with a polymerase, one or more nucleotides, a ligase, or any combination thereof. Other methods for replacing the “peeled-away” bases present in the flap are also known to those of ordinary skill in the art. The first DNA strand is suitably extended along the corresponding region of the second DNA, which region is left behind and exposed by the formation of the flap. In some embodiments, the polymerase acts concurrent with a nickase that gives rise to a flap.

In some embodiments, labeling comprises (a) binding at least one complementary probe to at least a portion of the flap, (b) utilizing, as a replacement base that is part of the first DNA strand extended along the corresponding region of the second DNA strand, a nucleotide comprising one or more tags, or any combination of (a) and (b). In this case, the flap, the bases that fill-in the gap, or both can be labeled. In some embodiments, the probe comprises one or more tags. Non-limiting examples of probes include nucleic acids (single or multiple) that include a tag, as described elsewhere herein. The probes can be randomly generated. In some embodiments, a probe can be sequence specific (e.g., AGGCTA, or some other particular base sequences. A probe can be selected or constructed based on the user's desire to have the probe bind to a sequence of interest or, in one alternative, bind to a sequence that up- or downstream from a sequence or other region of interest on a particular DNA polymer (i.e., probes that bind so as to flank or bracket a region of interest). The length of the probe can vary, for example, a probe can be as long as a flap, e.g., from about 1 base to about 1000 bases. In some embodiments, the length of the probe is about 2 bases, about 5 bases, about 10 bases, about 20 bases, about 30 bases, about 50 bases, about 100 bases, about 500 bases, about 1000 bases, or a range between any two of these values. The methods and systems for nicking and flap-labeling of a macromolecule have been described, for example, in Das et al., Nucleic Acids Res., 38(18):e177 (2010) and international patent application published as WO2010/002883, which is expressly incorporated herein by reference.

A user can also, in some embodiments, measure the distance between two flaps, between two or more tags disposed adjacent to two or more flaps, two or more tags disposed within two or more gaps, or any combination thereof. The distance can be correlated to structure, a sequence assembly, a genetic or cytogenetic map, a methylation pattern, a location of a cpG island, an epigenomic pattern, a physiological characteristic, or any combination thereof of the DNA. Be the methods disclose herein enable investigation of structure and of other epigenomic factors (e.g., .methylation patterns, location of cpG islands, and the like), the user can overlay results relating to structure and epigenomic patterns to arrive at a complete genomic picture.

Translocating includes applying a fluid flow, a magnetic field, an electric field, a radioactive field, a mechanical force, an electroosmotic force, an electrophoretic force, an electrokinetic force, a temperature gradient, a pressure gradient, a surface property gradient, a capillary flow, or any combination thereof. It is contemplated that translocating includes controllably moving at least a portion of the macromolecule into at least a portion of a fluidic nanochannel segment; moving at least a portion of the macromolecule through at least a portion of a fluidic nanochannel segment at a controlled speed and a controlled direction.

Monitoring includes displaying, analyzing, plotting, or any combination thereof. Ways of monitoring signals will be apparent to those of ordinary skill in the art. The one or more monitored signals include optical signals, radiative signals, fluorescent signals, electrical signals, magnetic signals, chemical signals, or any combination thereof.

Signals are, in some embodiments, generated by an electron spin resonance molecule, a fluorescent molecule, a chemiluminescent molecule, a radioisotope, an enzyme substrate, a biotin molecule, an avidin molecule, an electrical charged transferring molecule, a semiconductor nanocrystal, a semiconductor nanoparticle, a colloid gold nanocrystal, a ligand, a microbead, a magnetic bead, a paramagnetic particle, a quantum dot, a chromogenic substrate, an affinity molecule, a protein, a peptide, a nucleic acid, a carbohydrate, an antigen, a hapten, an antibody, an antibody fragment, a lipid, or any combination thereof. In some embodiments, the molecule is unlabeled and monitored by infrared spectroscopy, ultraviolet spectroscopy, or any combination thereof.

Devices capable of performing the monitoring include a detector disposed so as to be capable of receiving an optical signal originating from within one or more illuminated fluidic nanochannel segments. Suitable signal detectors include a charge coupled device (CCD) detection system, a complementary metal-oxide semiconductor (CMOS) detection system, a photodiode detection system, a photo-multiplying tube detection system, a scintillation detection system, a photon counting detection system, an electron spin resonance detection system, a fluorescent detection system, a photon detection system, an electrical detection system, a photographic film detection system, a chemiluminescent detection system, an enzyme detection system, an atomic force microscopy (AFM) detection system, a scanning tunneling microscopy (S TM) detection system, a scanning electron microscopy (SEM) detection system, an optical detection system, a nuclear magnetic resonance (NMR) detection system, a near field detection system, a total internal reflection (TIR) detection system, a patch clamp detection system, a capacitive detection system, or any combination thereof.

Various techniques for analyzing macromolecules, such as polynucleotides, using nanofluidic devices, have been described, for example, in international patent applications published as WO2008121828 and WO2010/135323. Each of these references is incorporated herein by reference.

### Methods for Identifying the Sources of Polynucleotides

A method for identifying the sources of the polynucleotides isolated from multiple biological samples is also disclosed herein. The method comprises: providing a plurality of biological samples wherein each of the plurality of biological samples comprises a polynucleotide; combining the plurality of biological samples in a plurality of pools, wherein each biological sample is present in at least two pools; obtaining structural information of the polynucleotides present in each pool; and assigning the polynucleotides to corresponding biological samples using the structural information obtained for the polynucleotides.

The method disclosed herein provides an effective way to identify the source of the polynucleotides isolated from multiple biological samples because the method can analyze the polynucleotides isolated from two or more biological samples simultaneously and thus eliminate the need to separately analyze the polynucleotide isolated from each of the biological samples. For example, individual biological samples can be combined to form two or more pools, wherein each biological sample is present in at least two pools. The polynucleotides present in the biological samples in each pool can be isolated and analyzed together in the nanochannels as discussed above. Because the polynucleotide from each biological sample is present in at least two pools, the structural information obtained for the polynucleotide in each pool can be compared to determine which biological sample a particular polynucleotide corresponds to. In some embodiments, the assigning the polynucleotides to corresponding biological samples comprises comparing the structural information of the polynucleotides present in each pool.

As a non-limiting example, when there are 96 biological samples (8 columns×12 rows), instead of analyzing the 96 samples separately, all 8 samples in a single row can be mixed and analyzed in a nanochannel array together and all 12 samples in a single column can be mixed and analyzed in a nanochannel array together. Since each sample is present in exactly two mixed samples (i.e., pool samples), the structural information of the polynucleotide present in each mixed sample can be compared to determine which row and which column a particular sample is from. As a result, all together only 20 pool samples (instead of 96 samples) need to be analyzed, and only 20 nanochannel arrays need to be used as compared to 96 nanochannel arrays. The method disclosed herein provides an almost 5 times reduction in the number of samples analyzed, and the number of the nanochannel arrays used.

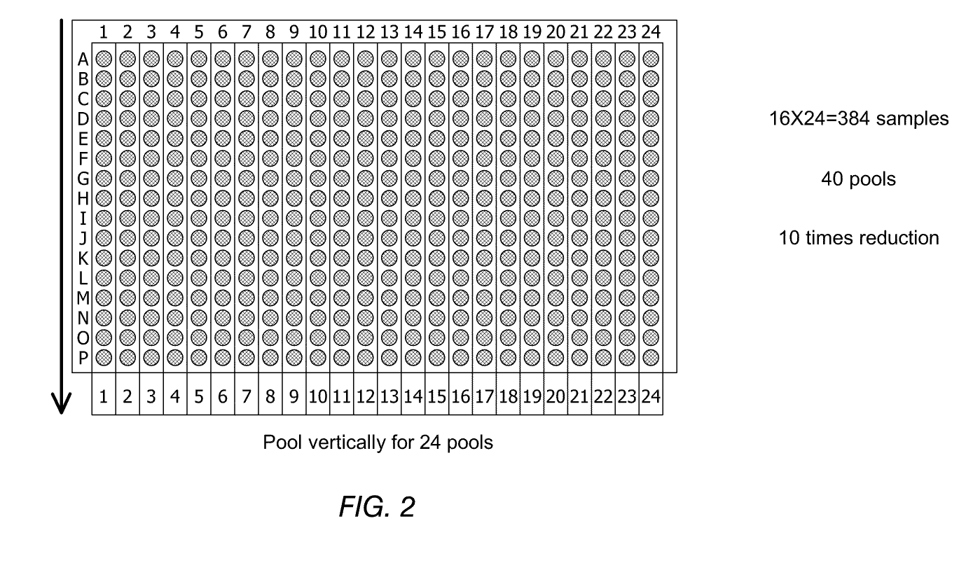

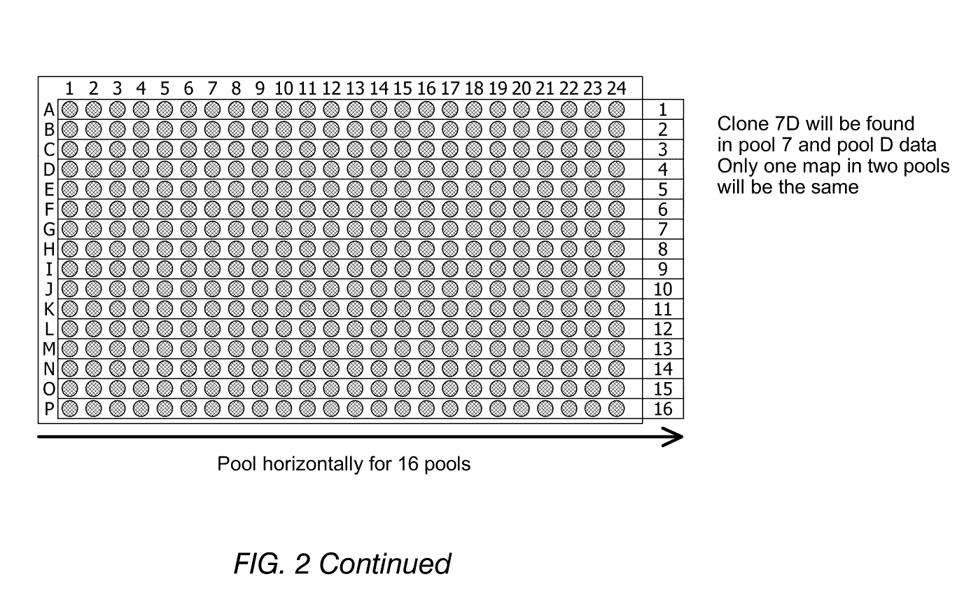

FIG. 2 illustrates another non-limiting example for the pooling methods disclosed herein, in which the unique signature of individual clones can be obtained by mapping two overlapping pool sets. In FIG. 2, each of the dot presents a BAC clone. To catalog a plate of 384 BAC clones and generate unique signature maps for individual clones, all 24 BAC clones in a single row can be mixed and analyzed in a nanochannel array, and all 16 BAC clones in a single column can be mixed and analyzed in a nanochannel array. As a result, only 40 pooled samples (i.e., 24 pools of each column (16 clones/pool) and 16 pools of each row (24 clones/pool)) need to be analyzed, which is a nearly ten-fold reduction in the number of test samples. As another non-limiting example, when there are N×M samples (N and M are positive integers), N+M pooled samples can be obtained and analyzed instead of analyzing N×M samples separately.

Further reduction can be achieved in larger sample size. For example, when there are 2304 samples, an about 24 fold reduction can be achieved by analyzed 96 pooled samples (i.e., 48 pools of each column (48 clones/pool) and 48 pools of each row (48 clones/pool)) as compared to the 2304 samples. And when there are 9216 samples, an about 48 fold reduction can be achieved by analyzed 192 pooled samples (i.e., 96 pools of each column (96 clones/pool) and 96 pools of each row (96 clones/pool)) as compared to the 9216 samples.

In the embodiments where the samples are BAC clones containing fragments of a polynucleotide of interest, in order to generate a good individual map of each clone from a mixed BAC sample, at least 20 fold coverage is desired. Considering the current DNA molecule capturing capacity of a single nanochannel array chip (minimal 9 Gbp/chip), 3000 clones can be run per chip. Therefore, for example, 9216 BAC clones can be analyzed in 192 pool samples containing 96 clones per pool on 3 chips, which gives 33 pools/chip. A user can further increase the ratio of pools/chip by improving the amount of the DNA captured per chip to triple or quadruple the minimal 9 Gb/chip through more efficient loading procedures.

Using the pool strategy disclosed herein, the extent of reduction in the number of samples to be analyzed can vary. For example, there can be at least about 5 fold, at least about 10 fold, at least about 20 fold, at least about 30 fold, at least about 40 fold, at least about 50 fold, at least about 80 fold, at least about 100 fold, or more reduction in the number of samples to be analyzed.

Any biological sample that contains a polynucleotide can be used in the method disclosed herein. For example, the biological sample can comprise bacterial cells, yeast cells, blood samples, insect cells, mammalian cells, tissue samples, and like. The biological sample can also comprise plasmids, fosmids, cosmids, viral vectors, artificial chromosome clones, or any combinations thereof that carry a polynucleotide fragment. The biological sample can also comprise an artificial chromosome clone carrying a polynucleotide fragment, such as a randomly sheared or restriction enzyme generated polynucleotide fragment. The artificial chromosome clone can be a bacterial artificial chromosome (BAC), a yeast artificial chromosome (YAC), a P1-derived artificial chromosome (PAC), or like. In some embodiments, the biological sample is a polynucleotide fragment, such as a randomly sheared or restriction enzyme generated polynucleotide fragment. The polynucleotide can be a fragment of a genomic DNA.

The polynucleotides in the biological samples can be isolated before or after the biological sample is combined to form pools. In some embodiments, the biological samples are combined to form two or more pools, and polynucleotides are isolated from the pools. In some embodiments, the polynucleotides present in one pool are loaded into the nanochannels as one sample.

In some embodiments, the assigning the polynucleotides to corresponding biological samples comprises comprising the structural information of the polynucleotides present in each pool.

In some embodiments, the obtaining structural information of the polynucleotides comprises sequencing at least a portion of the polynucleotides. In some embodiments, the obtaining structural information of the polynucleotides comprises generating a physical map of at least a portion of the polynucleotides. In some embodiments, the obtaining structural information of the polynucleotides comprises: labeling the polynucleotides present in each pool, and linearizing, in a nanochannel fluidic device, at least a portion of the labeled polynucleotides. As disclosed above, the methods disclosed herein can effectively identify the source of the polynucleotides without the need to analyze the polynucleotide in each sample separately. In some embodiments, the polynucleotides present in one pool are loaded into the nanochannel fluidic device as one sample or analyzed in the nanochannel fluidic device simultaneously.

In some embodiments, the structural information of the polynucleotides comprises patterns of distances between labels on the polynucleotides, intensity of the labels on the polynucleotides, or both. The structural information of the polynucleotides can be used to generate consensus maps of the polynucleotide s. These consensus maps are unique and can be used to identify each clone and catalog the exact location of each clone in the origin source. From the consensus maps, a physical map can be assembled by joining individual consensus maps, where sufficient overlap occurs. The physical maps and contigs can also be used as scaffolds for DNA sequence assembly.

The polynucleotides can be labeled using any of the methods known in the art and disclosed herein. The polynucleotides can be labeled at their DNA backbones and one or more regions on the polynucleotide. In some embodiments, the labeling comprises nicking, flapping-labeling, or any combination hereof. The polynucleotides can be labeled at one or more different sequence motifs and/or epigenomic sites of interest (e.g., methylation or transcription factor binding sites). In some embodiments, the polynucleotides are only labeled at one or more sequence motif. In some embodiments, the polynucleotides are only labeled at one or more epigenomic sites of interest. In some embodiments, the polynucleotides are labeled at one sequence motif or epigenomic site of interest. In some embodiments, the polynucleotides are labeled at two different sequence motifs or two epigenomic sites of interest. In some embodiments, the polynucleotides are labeled at two or more different sequence motifs, or two or more epigenomic sites of interest. The different sequence motifs or epigenomic sites of interest can be labeled by the same or different labels. For examples, the polynucleotides can be labeled at two different sequence motifs, wherein each sequence motif is labeled by a different label. The polynucleotides can also be labeled at a sequence motif and an epigenomic site of interest, wherein the sequence motif and the epigenomic site of interest are labeled by different labels. In some embodiments, the different sequence motifs or epigenomic sites of interest are labeled by the same label. Without being bound to a particular theory, it is believed that labeling the polynucleotides at more different sequence motifs or epigenomic sites of interest can increase labeling density, and thus increases the accuracy and effectiveness of the methods for obtaining structural information of the polynucleotides.

### Barcoding Individual Pools to Form Super Pools

The pools of biological samples containing polynucleotides can be further combined to form super-pools to further reduce the number of test samples need to be analyzed to increase the throughput and simplify the analysis. In some embodiments, multiple pools are combined to one or more super-pools, wherein at least one of the super-pools comprises two or more of the pools.

For example, each of the polynucleotides contained in the biological samples can be barcoded with a pool-specific identifier. As used herein, a “pool-specific identifier” refers to a nucleic acid sequence unique to the polynucleotides present in a single pool. In other words, the pool-specific identifier carried by the polynucleotides present in a pool is different from the pool-specific identifier carried by the polynucleotides present in any other pools. A pool-specific identifier can differ from other pool-specific identifiers in nucleic acid sequences or nicking patterns. The length of the pool-specific identifier can vary, for example, from about 10 bp to about 100 kb. For example, the length of the pool-specific identifier can be about 10 bp, about 100 bp, about 1 kb, about 5 kb, about 9 kb, about 10 kb, about 15 kb, about 20 kb, about 30 kb, about 50 kb, about 100 kb, or a range between any two of these values. In some embodiments, the pool-specific identifier is about 5 kb to about 50 kb.

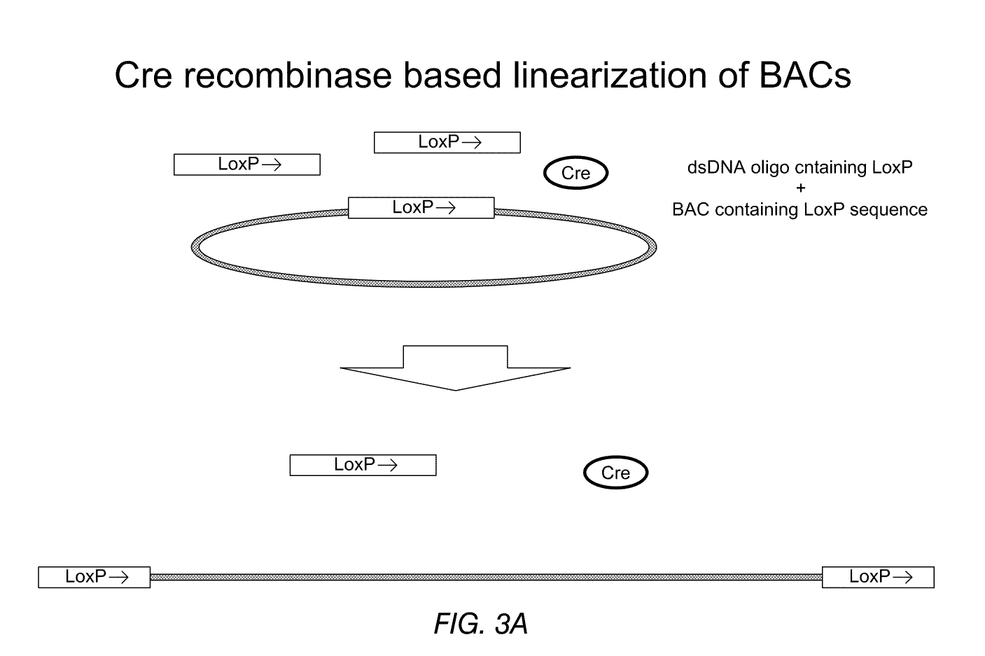

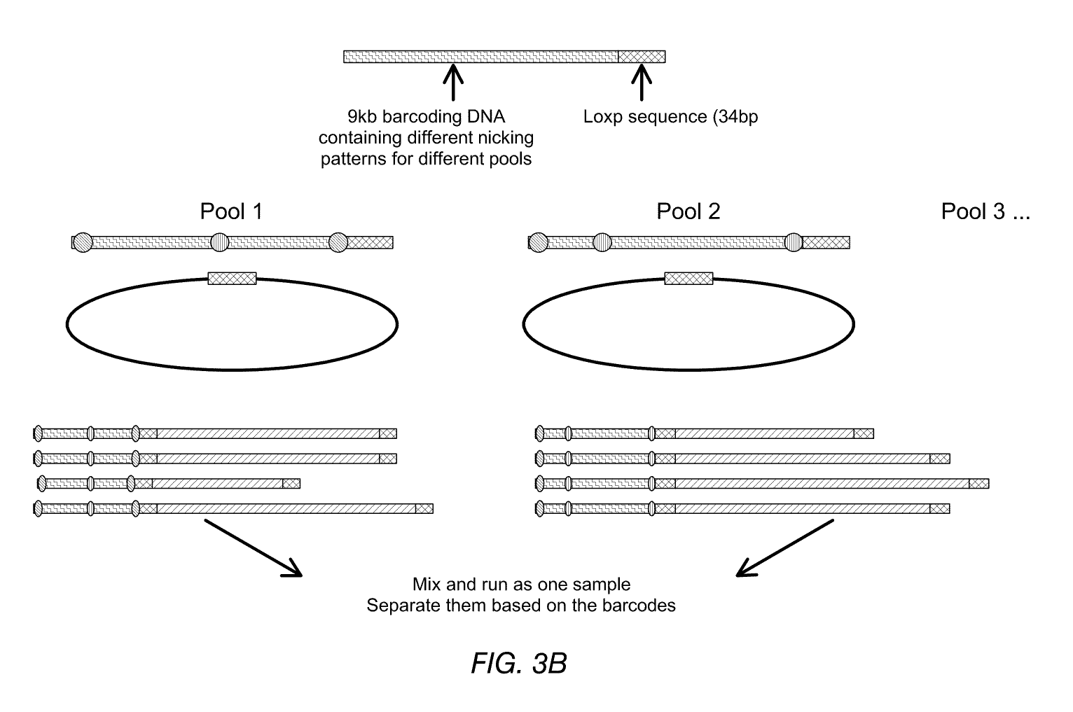

Various methods can be used to barcode the polynucleotides with pool-specific identifier. For example, a site-specific recombination system can be used to attach a pool-specific identifier to a polynucleotide. Examples of site-specific recombination system include, but are not limited to, Cre-LoxP recombination system and FLP-FRT recombination system. FIGS. 3A-B illustrates one non-limiting example of barcoding the polynucleotides within a single pool by introducing additional fluorescent labels at the end of the each clone using the Cre-LoxP recombination system. As shown in FIG. 3B, polynucleotides within pool 1 and 2 are barcoded with different pool-specific identifier, respectively, and can be mixed together to form a super pool. In some embodiments, a super pool can be analyzed as a single sample in a nanochannel fluidic device, and the structural information of the polynucleotides in the super pool can be obtained. By comparing the structural information of the polynucleotides in the super pool (including the pool-specific identifier carried by the polynucleotides), each polynucleotide can be assigned to its corresponding individual pools, and within individual pools, the consensus maps of individual polynucleotide can then be easily extracted using a clustering method.

In some embodiments, the polynucleotides present in one super-pool are loaded into nanochannels as one sample. In some embodiments, assigning the polynucleotides to corresponding biological samples comprises assigning the polynucleotides to corresponding pool based on the pool-specific identifiers present in the polynucleotides.

### Generating Physical Maps of Polynucleotides

Disclosed herein is a method for generating a physical map of a polynucleotide, comprising: providing a sample polynucleotide; generating a library of sub-polynucleotide clones wherein each sub-polynucleotide clone comprises a fragment of the sample polynucleotide; combining the sub-polynucleotide clones in a plurality of pools, wherein each sub-polynucleotide clone is present in at least two pools; labeling one or more regions of the fragments of the sample polynucleotide; linearizing, in nanochannels, at least a portion of the labeled region of the fragments of the sample polynucleotide; and obtaining structural information of the fragments of the sample polynucleotides based on the linearized and labeled fragments of the sample polynucleotides to generate a physical map of the sample polynucleotide. In some embodiments, the method further comprises assigning the fragments of the sample polynucleotide to corresponding sub-polynucleotide clones based on the structural information obtained for the fragments of the sample polynucleotides. In some embodiments, at least some of the fragments of the sample polynucleotide in the sub-polynucleotide clone overlap with each other.

In some embodiments, the sample polynucleotide is a genomic DNA. In some embodiments, the fragment of the sample polynucleotide is a randomly sheared or restriction enzyme generated fragment of the sample polynucleotide. The sub-polynucleotide clones can be plasmids, fosmids, cosmids, viral vectors, artificial chromosome clones, or any combinations thereof.

In some embodiments, the structural information of the polynucleotides comprises patterns of distances between labels on the polynucleotides, intensity of the labels on the polynucleotides, or both.

In some embodiments, the polynucleotides present in one pool are loaded into the nanochannels as one sample. In some embodiments, each of the polynucleotides comprises a pool-specific identifier.

In some embodiments, the method further comprises combining the plurality of pools in a plurality of super-pools, wherein each of the super-pool comprises one or more of the pools. In some embodiments, the polynucleotides present in one super-pool are loaded into the nanochannels as one sample. In some embodiments, assigning the polynucleotides to corresponding sub-polynucleotide clones comprises assigning the polynucleotides to corresponding pool based on the pool-specific identifiers present in the polynucleotides.

The method disclosed herein is applicable to different aspects of genomic DNA analysis, for example, generating physical maps of genomic DNA, assembling genome maps, assisting sequencing and sequence assembly of genomic DNA, discovering structural variations among different haplotypes, and discovering epigenomic patterns in genomic DNA.

### Methods and Systems for High Characterization of Macromolecules

Methods and systems capable of performing high throughput characterization of macromolecules, such as polynucleotides, using nanofludic devices are enclosed herein. The methods comprise: labeling a plurality of macromolecules, wherein each macromolecule is labeled on at least two locations and wherein the plurality of macromolecules comprises two or more macromolecules; translocating the labeled macromolecules through a nanochannel array, wherein at least a portion of the labeled macromolecules is elongated within the nanochannel array and wherein the nanochannel array comprises two or more nanochannels; monitoring one or more signals related to the translocation of the labeled macromolecules through the nanochannel array, wherein signals from at least two macromolecules are monitored simultaneously, wherein the monitoring comprises determining the distance between labels on the labeled macromolecules; and correlating the distances between the labels to one or more characteristics of the macromolecules.

The systems for high throughput characterization of macromolecules comprise: a nanochannel array, wherein the nanochannel array comprises two or more nanochannels; an image collector capable of capturing an image of the nanochannel array; and a computer processor configured to manipulate one or more images of the nanochannel array gathered by the image collector. Depending on the capability of the image collector, the image collector can capture an image of a portion or entire nanochannel array simultaneously. In some embodiments, the image collector is capable of capturing an image of the entire nanochannel array simultaneously. In some embodiments, the image collector further comprises a scanner which is configured to scan the nanochannel array to capture images of portions of the nanochannel array. In some embodiments, the image collector takes about 2 seconds, about 5 seconds, about 10 seconds, about 30 seconds, about 45 seconds, about one minute, about two minutes, about 5 minutes, about 10 minutes to scan the whole imaging area of the nanochannel array.

In some embodiments, wherein the image collector has a single field of view of at least about 50 micron x 50 micron. In some embodiments, the image collector is capable of capturing an image of at least about 50 nanochannels simultaneously. In some embodiments, wherein the image collector is capable of capturing an image of at least about 160 nanochannels simultaneously.

In the methods and systems disclosed herein, the number of nanochannels present in the nanochannel array can vary. For example, the nanochannel array can have at least about 3 nanochannels, at least about 10 nanochannels, at least about 20 nanochannels, at least about 30 nanochannels, at least about 50 nanochannels, at least about 80 nanochannels, at least about 100 nanochannels, or at least about 150 nanochannels. The number of macromolecules in the plurality of macromolecules can also vary. For example, the plurality of macromolecules can have at least about 3 macromolecules, at least about 10 macromolecules, at least about 20 macromolecules, at least about 30 macromolecules, at least about 50 macromolecules, at least about 80 macromolecules, at least about 100 macromolecules, or at least about 150 macromolecules. In some embodiments, signals from at least about 3 macromolecules, at least about 10 macromolecules, at least about 20 macromolecules, at least about 30 macromolecules, at least about 50 macromolecules, at least about 80 macromolecules, at least about 100 macromolecules, or at least about 150 macromolecules are monitored simultaneously. The macromolecules can be proteins, single-stranded DNA, double-stranded DNA, RNA, siRNA, or any combination thereof.

In some embodiments, the plurality of macromolecules is loaded onto the nanochannel array as one sample.

The monitoring one or more signals related to the translocation of the labeled macromolecules can be performed by any conventional methods known in the art. For example, the monitoring can be performed visually. In some embodiments, the monitoring comprises capturing the information of signals in a computer.

As a non-limiting example for high throughput capturing of DNA image in nanochannel arrays, a 512×512 ECCD camera with a single field of view of about 83 micro by 83 micron in size can be used as the image collector. An image size of 83 micro by 83 micron can include about 160 nano-channels. The total length of the channels in one field is about 160×83 microns=13,280 micron. At 65% DNA stretching and 0.34 nm/single base pair, a single field of view can accommodate, if the channels are fully occupied by DNA molecules, roughly 13,280/0.65/0.34=60 Mbp of genomic DNA. Under the about 20% occupancy, about 12 Mbp of genomic DNA can be examined in a single field of view.

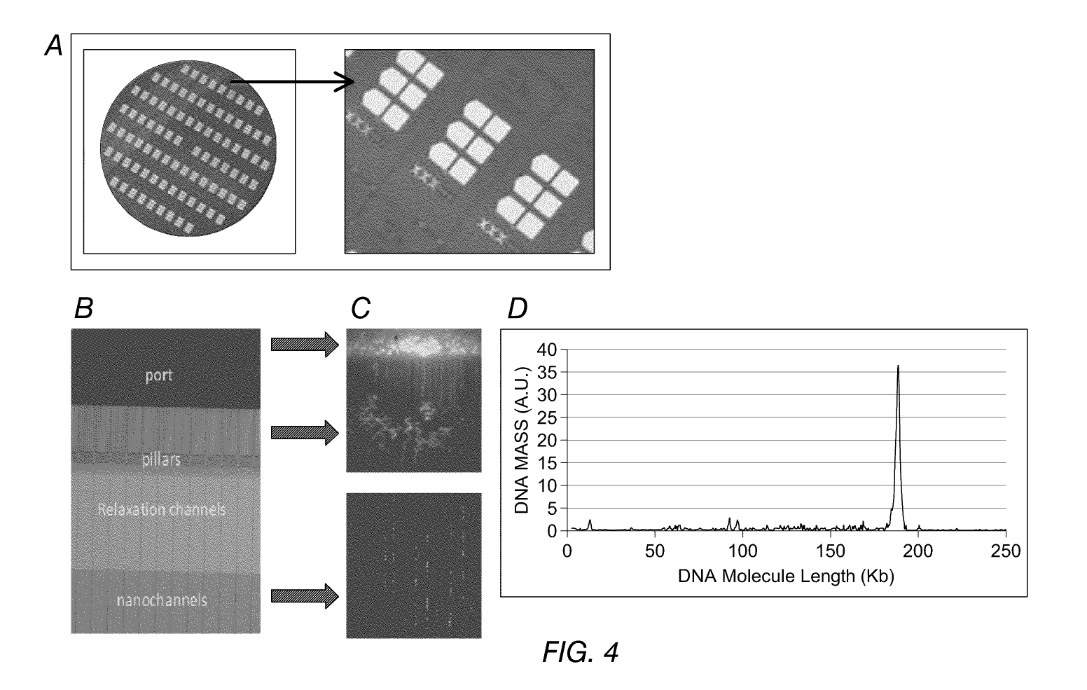

The imaging area of a non-limiting example of nano-channel array chip is about 400 microns long and 10 mm wide. With an automated image capture system that takes about one minute to scan the whole imaging area and generate about 128 single color images, imaging three colors can take three minutes, which translates into 12 Mb×128 fields=1.5 Gbp per scan. Even including the loading and equilibrating time, a user can achieve roughly 30 Gbp reading capacity in about 60 minutes. FIG. 4 illustrates a non-limiting example of the nano-channel array chip.

To deliver coverage of large genome in even higher throughout, an imaging system configured to do continuous raster scanning covering hundreds of fields of view can be used. Moreover, the use of camera with larger single field view or chips containing more nanochannels can also improve the throughput.

### EXAMPLES

Additional embodiments are disclosed in further detail in the following examples, which are not in any way intended to limit the scope of the claims.

### Example 1

### Efficient and Sequence-Specific Fluorescent Labeling

This example illustrates a non-limiting example showing a nick-flap labeling scheme for labeling sequence specific motifs on double-stranded DNA molecules and maintain the integrity of the double-stranded DNA.

In the nick-flap labeling scheme, hybridization probes capable of recognizing any sequences across the whole genome on ds-DNA molecules under non-denaturing conditions can be used. See Xiao et al., Nucleic Acids Res., 35(3), e16 (2007), which is expressly incorporated herein by reference. As described in Morgan et al., Biological Chemistry, 381: 1123-1125 (2000), the nicks can be introduced in double-stranded DNA at specific sequence motifs recognized by nicking endonucleases, which cleave only one strand of a double-stranded DNA substrate. In the direct nick-labeling scheme, fluorescent dye nucleotides can be directly incorporated by DNA polymerase extension, which indicates the presence of nicking endonuclease recognition sequences. In the flap-labeling scheme, a polymerase with 5′-3′ displacement activity but lacking 5′-3′ exonuclease activity such as Vent (exo-) can be used for strand extension and displacement of the downstream strand from the nicking sites. The displaced single stranded DNA sequence segments form flap structures attached to intact double stranded DNA molecules, which open up more sequences for further information beyond the nicking endonuclease recognition sequences. The nicking sites and flap sequences can be labeled at the same time, that is nick-flap labeling.

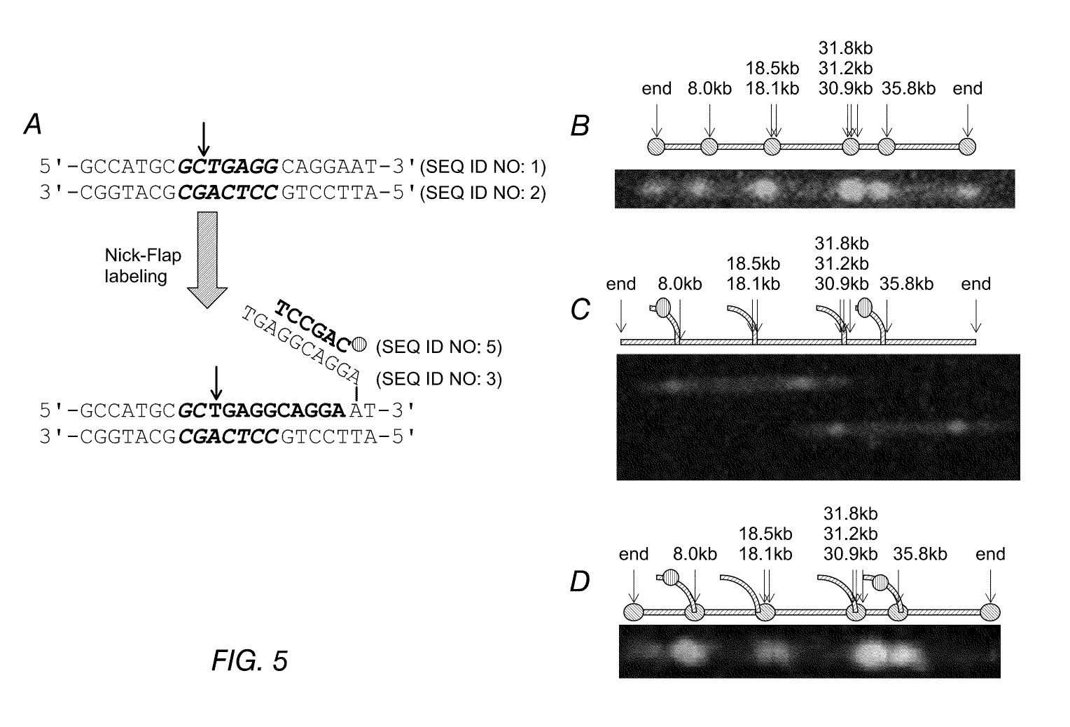

A non-limiting example of the nick-flap labeling scheme, using nicking endonuclease Nb.BbvCI on lambda DNA, is shown in FIG. 5A-D. The distributions of the seven nick endonuclease Nb.BbvCI recognition sequences (GCTGAGG) of lambda DNA are shown in the top graph of FIG. 5B. There are two nicking sites at ˜18.3 kb and three nicking sites at ˜31.3 kb, which are separated by no more than 1000bp, and thus clustered as one optically resolvable spot at each of these locations. Accordingly, the seven Nb.BbvCI sites of lambda DNA are collapsed to 4 resolvable sites at 8 kb, 18.3 kb (average of 18.1 kb and 18.5 kb), 31.3 kb (average of 30.9 kb, 31.2 kb and 31.8 kb), and 35.8 kb. A typical labeled DNA molecule is shown in FIG. 5D, showing the experimental data matches well with the predicted map. The resolution is better than 5 kb, as the two spots at 31.3 kb and 35.8 kb are clearly resolvable. The labeling is very specific due to two enzymatic reactions: DNA nicking by nicking endonuclease and fluorescent dye nucleotide incorporation by polymerase. Furthermore, the fluorescent dye molecules are covalently bound to the ds-DNA. Instead of directly tagging the recognition sequences, flap structures can be generated, opening up more sequences other than the nicking enzyme recognition sequences for selective interrogation. FIG. 5C shows that two lambda DNA molecules were selectively labeled at the 8 kb and 35.8 kb flap sites with two sequence specific hybridization probes targeting these two flap sites, and the integrity of the double-stranded DNA molecules was maintained. The maintenance of the integrity of the double-stranded DNA molecules can be accomplished by limiting the flap length, for example a flap with a length of no more than about 50 base pair, with the combination of amount of polymerase used, reaction temperature, reaction time, and the amount of nucleotide used in the reaction.

Probes designed to hybridize the sequences after 50 bp showed minimal hybridization events, demonstrating that the flap length can be limited to 50 bp. With 300 full length lambda DNA molecules analyzed, 85% of the two targeted flap sites were labeled. By combining the nick and flap labeling strategies, a user can globally label all nicking sites and at the same time selectively label the individual flap sites. One of such labeled lambda molecules is shown in FIG. 5D. In this case, all the nicking recognition sequences of the lambda DNA molecule are tagged by incorporation of fluorescent nucleotides (a first label)), and two flap sites at 8 kb and 35.8 kb were hybridized and labeled with two sequence specific probes (a second label that is different from the first label).

### Example 2

### Pooled Bacterial Artificial Chromosome (BAC) Clone Mapping

This non-limiting example shows how a pooled clone mapping strategy was used to improve the throughput of DNA analysis utilizing the high capacity of nanochannel arrays.

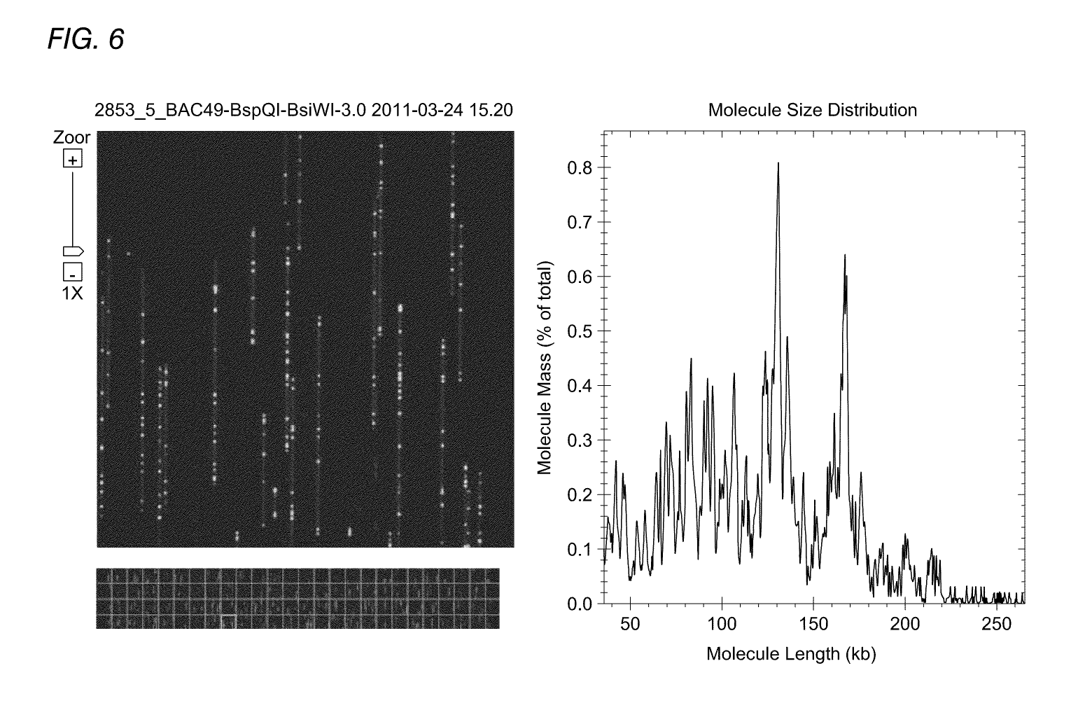

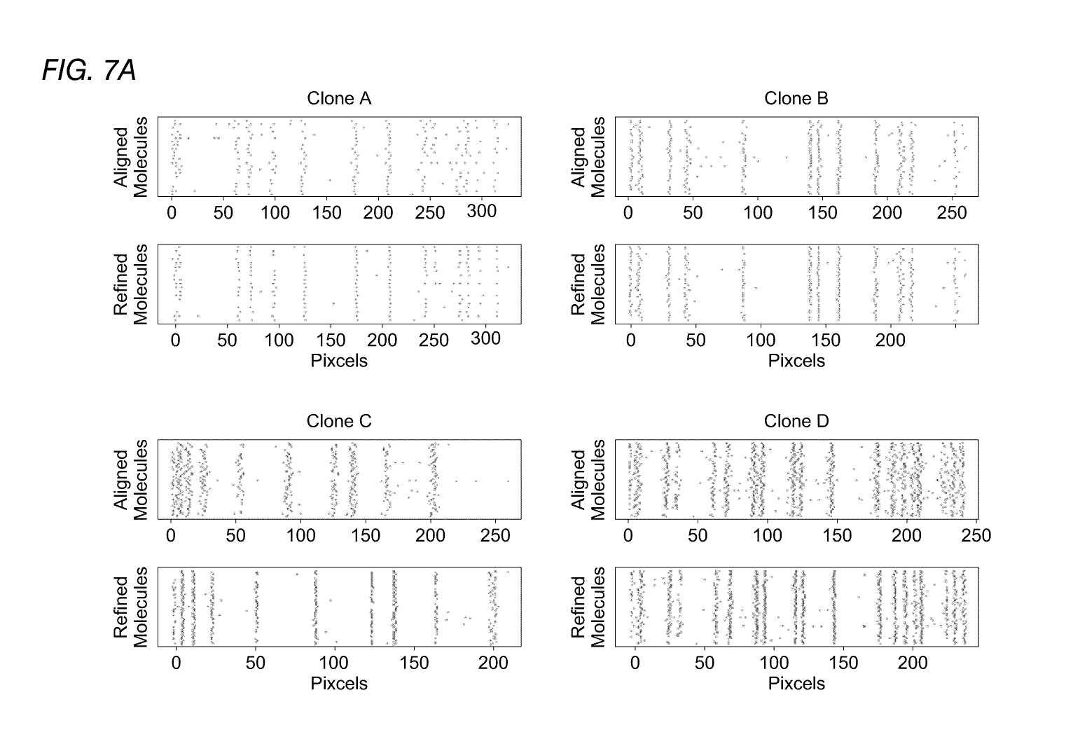

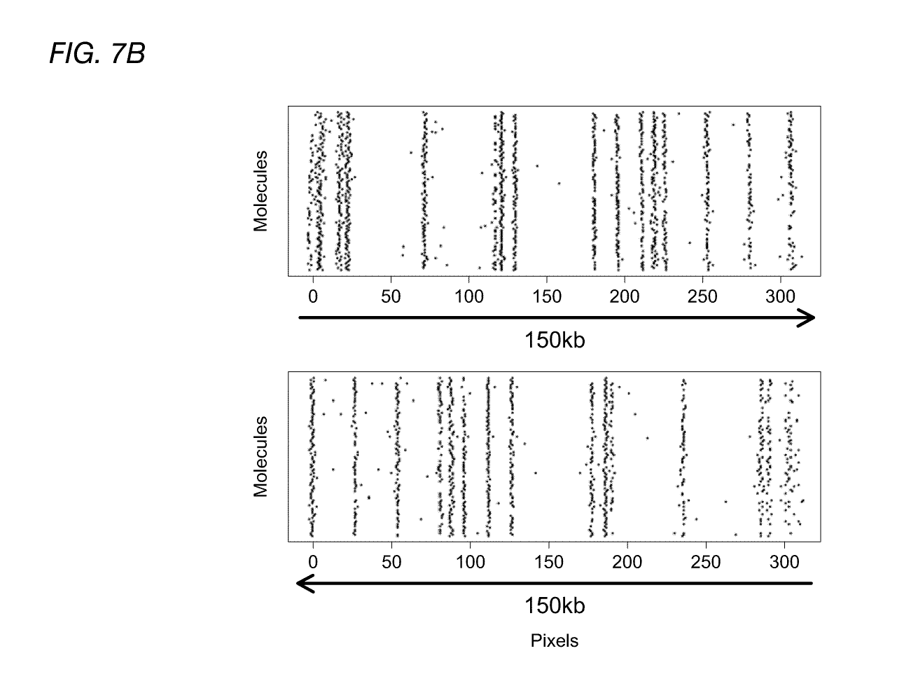

Cultures of 50 individual BAC clones were grown and mixed together to make one DNA preparation. After obtaining the mixture of clone DNA samples, nick-labeling was performed and the optical maps of DNA mixtures were obtained in a high-throughput fashion (FIG. 6). The individual clone maps were extracted by a clustering method. FIGS. 7A-B show a few clusters of individual clones extracted from the mixture of 50 clones. In general, two clusters were formed for each BAC clone as the clone can enter the nanochannel in either orientation.

Using the pooled clone mapping strategy, each individual BAC clone was distinguished from each other in a mixture of 50 BAC clones.

### Example 3

### Physical Map Construction

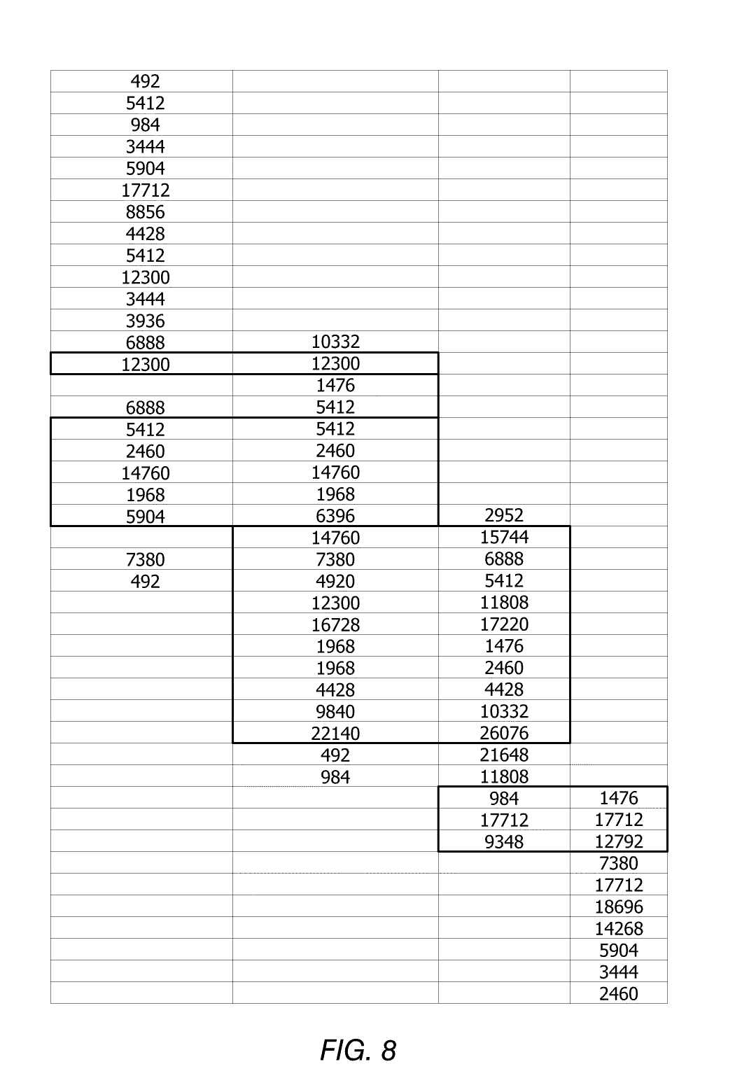

A library of BAC clones containing fragments of a genomic DNA is provided. The BAC clones are mixed together to form a pool. The fragments of the genomic DNA are isolated from the pool, labeled and analyzed using nanochannels. The distances between labels on the fragments of the genomic DNA are monitored and recorded to obtain the consensus map of each DNA fragment carried in the individual BAC clone. After the consensus map of the genomic DNA fragment from each individual BAC clone is obtained, the consensus maps of individual clusters are joined to form a complete physical map of the genomic DNA computationally. A non-limiting map of four overlapping BAC clones is shown in FIG. 8.

### Example 4

### Construction of a 4.67 Mb Physical Map of Human Chromosome 6 MEW Region

BAC libraries of genomic DNAs from two different individuals were obtained. Each of the BAC libraries covers a single haplotype of the same contiguous region of the MEW locus. Individual BAC clones in the libraries were grown separately and then mixed together into two pools (one for each library) before BAC DNA purification. After purification, the BAC DNAs were linearized by 3 different methods and nick-labeled with Nt.BspQI. Structural information of the BAC DNAs was collected in the nano-channel array for each of the six samples and analyzed by identification of the YOYO stained DNA backbone and the alexafluor-546 labeled nick locations overlayed on the backbone.

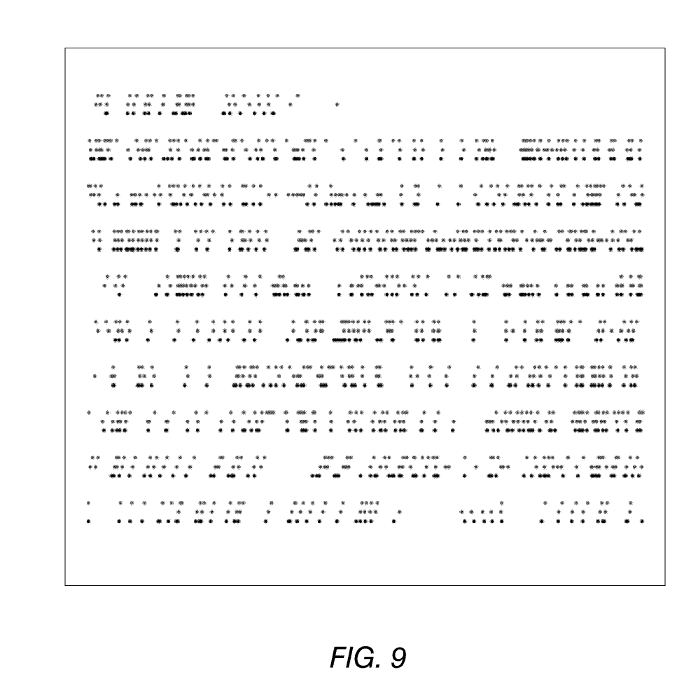

Fragments of genomic DNAs carried in the BAC clones were mapped to the reference sequence based on the distances between labels. Fragments of genomic DNAs were also clustered into groups which had high similarity, resulting in two clusters for each clone in the pools, one in forward and one in reverse orientation. By doing this, a consensus map was created for each BAC clone in both pools. The consensus map is also a unique signature that can represent a BAC clone and be used for cataloging purposes. The consensus map of each cluster are then compared and joined to form physical map as shown in FIG. 9.

### Example 5

### Discovery of Structural Variations in Human Genomes

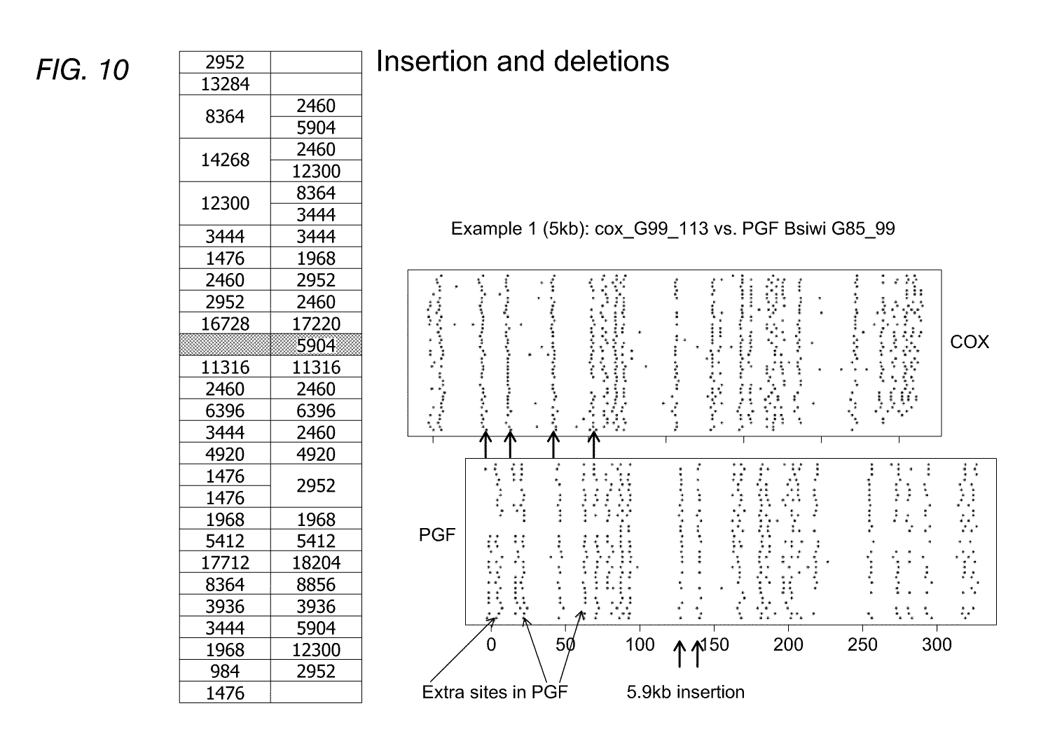

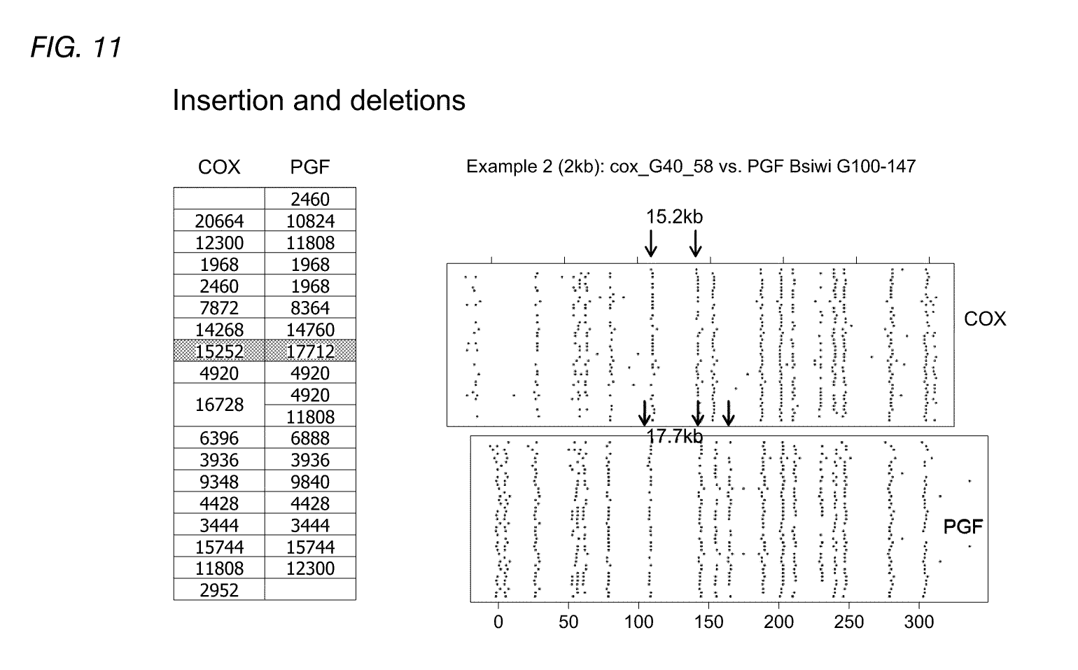

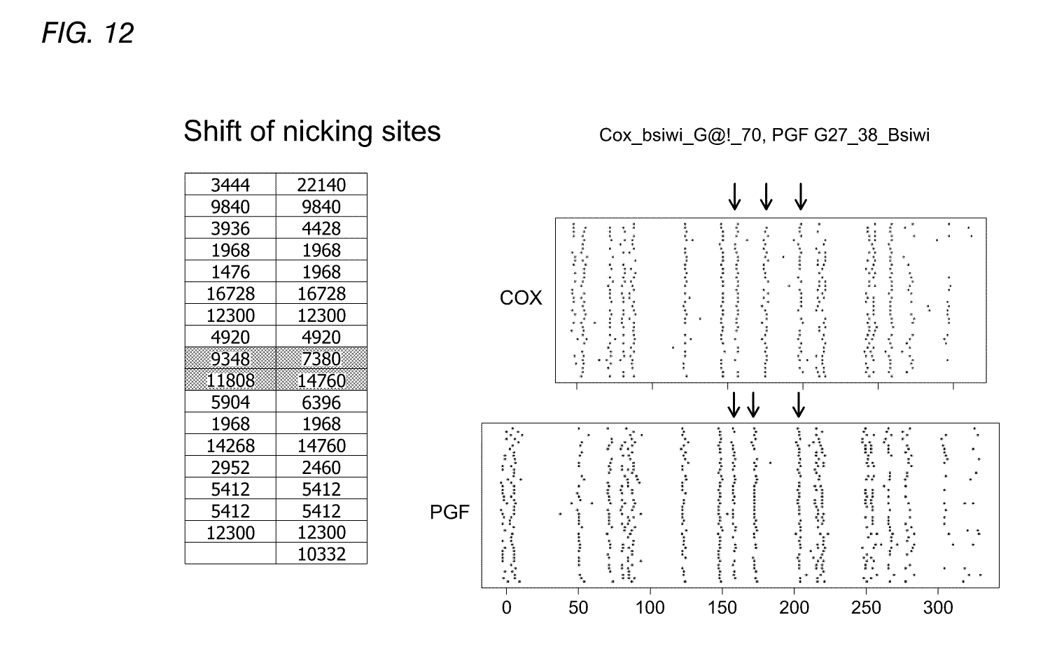

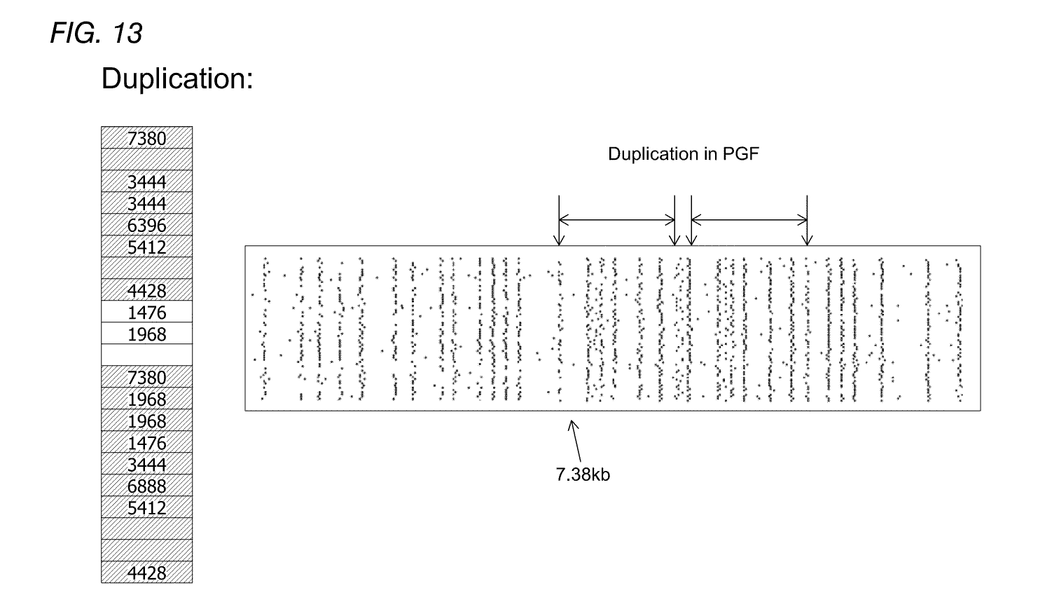

BAC libraries of genomic DNAs from a 4.67 Mb region on Chromosome 6 from two different individuals were obtained. Physical maps of the 4.67 Mb region for the two individuals were obtained according to the general procedure described in Example 4. The resulting physical maps from the two different individuals were compared to identify structural variations in the 4.67 Mb MEW region on chromosome 6. As shown in FIGS. 10-13, various structural variations, such as insertions, deletions and duplications, between the 4.67 Mb genomic regions of the two different individuals were discovered.

### Example 6

### Improvement of Shotgun Sequencing Assembly

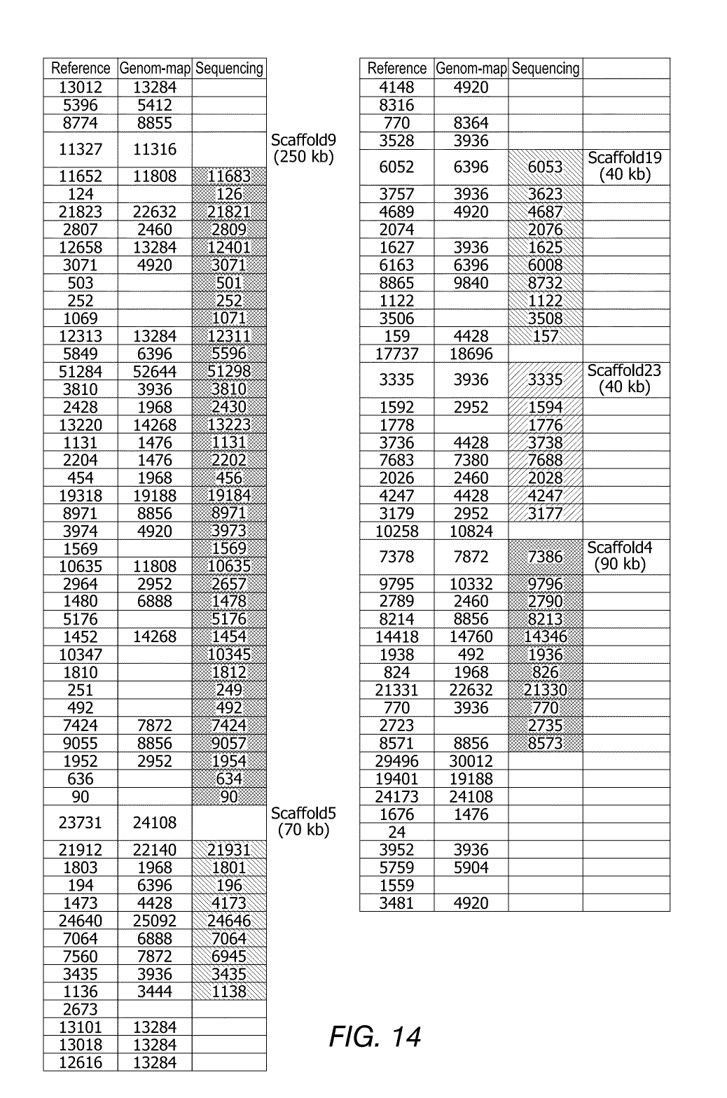

The physical maps generated in Examples 3 and 4 were compared with shotgun sequencing assembly to join the unlinked sequencing contigs and correct mis-assembly. As shown in FIGS. 14, physical maps obtained by the methods disclosed herein can be used to improve sequencing assembly, for example, the shotgun sequencing assembly.

### Example 7

### Generation of Physical Maps Using Multiple Sequence Motifs and Multiple Labeling

In this example, two nicking enzymes were used to nick fragments of a polynucleotide, where each of the nicking enzymes recognize a different sequence motif; and two different labels, e.g., labels with different colors, were used to label the polynucleotides. Without being bound to a particular theory, it is believed that labeling the polynucleotides at more different sequence motifs can increase labeling density, and thus increases the accuracy and effectiveness of the methods for obtaining structural information of the polynucleotides. Also, labeling two sequence motifs with two colors can increase the information density and uniqueness of maps, facilitation map construction and sequence assembly.

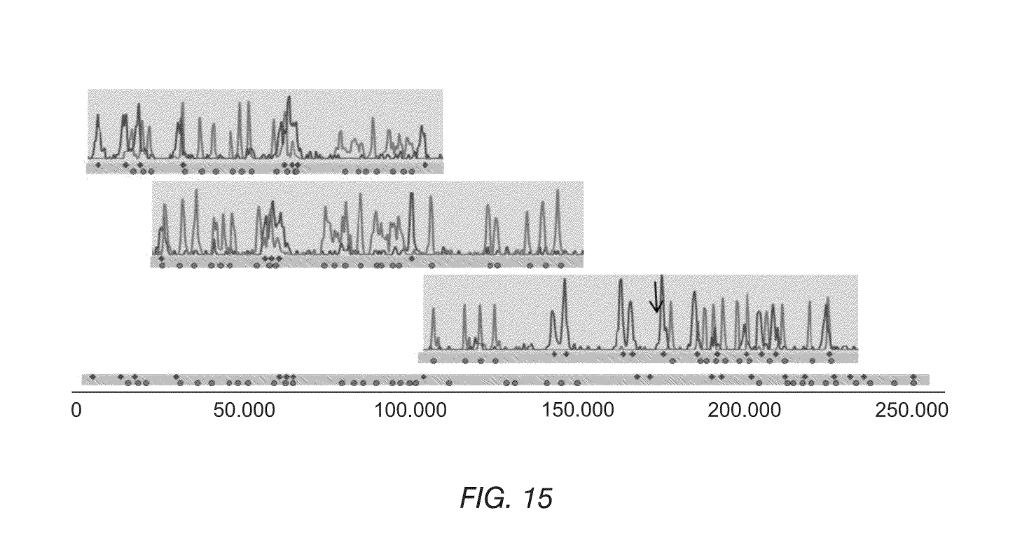

FIG. 15 shows a physical map of the polynucleotide that was generated by assembling three overlapping fragments of the polynucleotide. The diamonds on the top of the map represent the locations of the first label on the polynucleotide, and the solid dots at the bottom of the map represent the locations of the second label on the polynucleotide.

### Example 8

### Improving Sequence Assemblies Using Multiple Sequence Motifs and Multiple Labeling

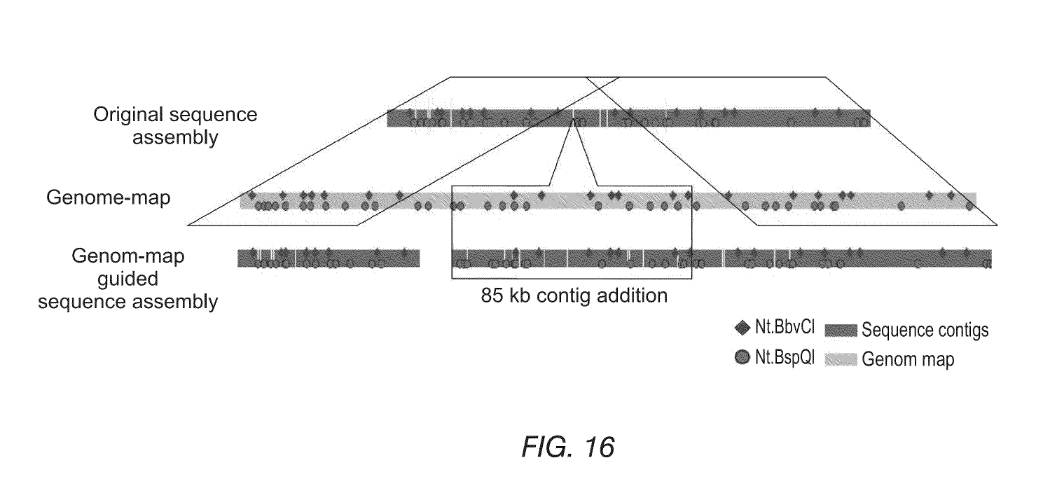

In this example, two nicking enzymes were used to nick fragments of a polynucleotide, where each of the nicking enzymes recognize a different sequence motif; and two different labels, e.g., labels with different colors, were used to label the polynucleotides. Because of the higher labeling density using two labeling colors as compared to one, an additional 85 kb contig was found. Corresponding correction of the sequence assembly was performed as illustrated in FIG. 16.

All references cited herein, including but not limited to published and unpublished applications, patents, and literature references, are incorporated herein by reference in their entirety and are hereby made a part of this specification. To the extent the publications and patents or patent applications incorporated by reference contradict the disclosure contained in the specification, the specification is intended to supersede and/or take precedence over any such contradictory material.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

One skilled in the art will appreciate that, for this and other processes and methods disclosed herein, the functions performed in the processes and methods can be implemented in differing order. Furthermore, the outlined steps and operations are only provided as examples, and some of the steps and operations can be optional, combined into fewer steps and operations, or expanded into additional steps and operations without detracting from the essence of the disclosed embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A method for identifying the source of polynucleotides, comprising:
providing a plurality of biological samples wherein each of the plurality of biological samples comprises a polynucleotide;
combining the plurality of biological samples in a plurality of pools, wherein each biological sample is present in at least two pools;
obtaining structural information of the polynucleotides present in each pool; and
assigning the polynucleotides to corresponding biological samples using the structural information obtained for the polynucleotides.

2. The method of claim 1, wherein the biological samples comprise randomly sheared or restriction enzyme generated polynucleotide fragments or such fragments carried in plasmids, fosmids, cosmids, viral vectors, artificial chromosome clones, or any combinations thereof.

3. The method of claim 2, wherein the artificial chromosome clones are Bacterial Artificial Chromosomes, Yeast Artificial Chromosomes, or any combinations thereof.

4. The method of claim 2, wherein each of the polynucleotide fragment present in the artificial chromosomes is a fragment of a genomic DNA.

5. The method of claim 1, wherein the obtaining structural information of the polynucleotides comprises sequencing at least a portion of the polynucleotides.

6. The method of claim 1, wherein the obtaining structural information of the polynucleotides comprises
labeling the polynucleotides present in each pool, and
linearizing, in a nanochannel fluidic device, at least a portion of the labeled polynucleotides.

7. The method of claim 6, wherein the polynucleotides present in one pool are loaded into the nanochannel fluidic device as one sample.

8. The method of claim 6, wherein the polynucleotides present in one pool are analyzed in the nanochannel fluidic device simultaneously.

9. The method of claim 6, wherein the labeling comprises nicking, flap-labeling, or any combination thereof.

10. The method of claim 6, wherein the labeling comprises labeling one or more different sequence motifs.

11. The method of claim 6, wherein the labeling comprises labeling two or more different sequence motifs by the same or different labels.

12. The method of claim 11, wherein the different sequence motifs are labeled by different labels.

13. The method of claim 1, wherein the assigning the polynucleotides to corresponding biological samples comprises comparing the structural information of the polynucleotides present in each pool.

14. The method of claim 6, the structural information of the polynucleotides comprises patterns of distances between labels on the polynucleotides, intensity of the labels on the polynucleotides, or both.

15. The method of claim 1, wherein each of the polynucleotides comprises a pool-specific identifier.

16. The method of claim 15, wherein the pool-specific identifier is about 5 kb to about 50 kb.

17. The method of claim 15, wherein each of the pool-specific identifier differs from other pool-specific identifiers in nicking patterns.

18. The method of claim 15, further comprising combining the plurality of pools in a plurality of super-pools, wherein at least one of the super-pools comprises two or more of the pools.

19. The method of claim 18, wherein the polynucleotides present in one super-pool are loaded into the nanochannel fluidic device as one sample.

20. The method of claim 18, wherein the assigning the polynucleotides to corresponding biological samples comprises assigning the polynucleotides to corresponding pool based on the pool-specific identifiers present in the polynucleotides.

21. A method for generating a physical map of a polynucleotide, comprising:
providing a sample polynucleotide;
generating a library of sub-polynucleotide clones wherein each sub-polynucleotide clone comprises a fragment of the sample polynucleotide;
combining the sub-polynucleotide clones in a plurality of pools, wherein each sub-polynucleotide clone is present in at least two pools;
labeling one or more regions of the fragments of the sample polynucleotide;
linearizing, in nanochannels, at least a portion of the labeled region of the fragments of the sample polynucleotide; and
obtaining structural information of the fragments of the sample polynucleotides based on the linearized and labeled fragments of the sample polynucleotide to generate a physical map of the sample polynucleotide.

22. The method of claim 21, the sample polynucleotide is a genomic DNA.

23. The method of claim 21, further comprising assigning the fragments of the sample polynucleotide to corresponding sub-polynucleotide clones based on the structural information obtained for the fragments of the sample polynucleotides.

24. The method of claim 21, the structural information of the polynucleotides comprises patterns of distances between labels on the polynucleotides, intensity of the labels on the polynucleotides, or both.

25. The method of claim 21, wherein the polynucleotides present in one pool are loaded into the nanochannels as one sample.

26. The method of claim 21, wherein the labeling comprises nicking, flap-labeling, or any combination thereof.

27. The method of claim 21, wherein the labeling comprises labeling two or more different sequence motifs by the same or different labels.

28. The method of claim 27, wherein the different sequence motifs are labeled by different labels.

29. The method of claim 21, wherein each of the polynucleotides comprise a pool-specific identifier.

30. The method of claim 27, further comprising combining the plurality of pools in a plurality of super-pools, wherein each of the super-pool comprises one or more of the pools.

31. The method of claim 30, wherein the polynucleotides present in one super-pool are loaded into the nanochannels as one sample.

32. The method of claim 30, wherein assigning the polynucleotides to corresponding sub-polynucleotide clones comprises assigning the polynucleotides to corresponding pool based on the pool-specific identifiers present in the polynucleotides.

33. A high throughput method of characterizing macromolecules using a nanofluidic device, comprising:
labeling a plurality of macromolecules, wherein each macromolecule is labeled on at least two locations and wherein the plurality of macromolecules comprises at least 20 macromolecules;
translocating the labeled macromolecules through a nanochannel array, wherein at least a portion of the labeled macromolecules is elongated within the nanochannel array and wherein the nanochannel array comprises two or more nanochannels;
monitoring one or more signals related to the translocation of the labeled macromolecules through the nanochannel array, wherein signals from at least 20 macromolecules are monitored simultaneously, wherein the monitoring comprises determining the distance between labels on the labeled macromolecules; and
correlating the distances between the labels to one or more characteristics of the macromolecules.

34. The method of claim 33, wherein the plurality of macromolecules is loaded onto the nanochannel array as one sample.

35. The method of claim 33, wherein the monitoring one or more signals related to the translocation of the labeled macromolecules comprises capturing the information of signals in a computer.

36. The method of claim 33, wherein the plurality of macromolecules comprise proteins, single-stranded DNA, double-stranded DNA, RNA, siRNA, or any combination thereof.

37. A system, comprising:
a nanochannel array, wherein the nanochannel array comprises at least 50 nanochannels;
an image collector capable of capturing an image of the nanochannel array; and
a computer processor configured to manipulate one or more images of the nanochannel array gathered by the image collector.

38. The system of claim 37, wherein the image collector is capable of capturing an image of the entire nanochannel array simultaneously.

39. The system of claim 37, wherein the image collector further comprises a scanner which is configured to scan the nanochannel array to capture images of portions of the nanochannel array.

40. The system of claim 37, wherein the image collector has a single field of view of at least about 50 micron x 50 micron.

41. The system of claim 37, wherein the image collector is capable of capturing an image of at least about 50 nanochannels simultaneously.

42. The system of claim 37, wherein the image collector is capable of capturing an image of at least about 160 nanochannels simultaneously.


SEQUENCE LISTING (5 sequences)

SEQ ID NO: 1 - DNA, 21 bp, Artificial Sequence
  Synthetic nucleotide
gccatgcgctgaggcaggaat

SEQ ID NO: 2 - DNA, 21 bp, Artificial Sequence
  Synthetic nucleotide
attcctgcctcagcgcatggc

SEQ ID NO: 3 - DNA, 10 bp, Artificial Sequence
  Synthetic nucleotide
tgaggcagga

SEQ ID NO: 4 - DNA, 7 bp, Artificial Sequence
  Synthetic nucleotide
gctgagg

SEQ ID NO: 5 - DNA, 6 bp, Artificial Sequence
  Synthetic nucleotide
cagcct